(19) United States
(12) Patent Application Publication
(10) Pub. No.: US 2018/0263729 A1
(43) Pub. Date: Sep. 20, 2018

(54) Dental Protection Assembly

(71) Applicant: Dale Council, Sunnyvale, CA (US)

(72) Inventor: Dale Council, Sunnyvale, CA (US)

(21) Appl. No.: 15/459,545

(22) Filed: Mar. 15, 2017

(51) Int. Cl. A61C 5/90

(52) U.S. Cl. CPC A61C 5/90

(57) ABSTRACT

A dental protection assembly includes a first shield that is selectively worn on an upper set of teeth. The first shield is comprised of a fluid impermeable material to inhibit food and liquid from contacting the upper set of teeth. The first shield is partially comprised of a deformable material. A first adhesive is positioned on the first shield to adhere to the upper set of teeth. A second shield is selectively worn on a lower set of teeth. The second shield is comprised of a fluid impermeable material to inhibit food and liquid from contacting the lower set of teeth. The second shield is partially comprised of a deformable material. A second adhesive is positioned on the second shield to adhere to the lower set of teeth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to dental devices and more particularly pertains to a new dental device for protecting teeth from food debris while eating.

### BRIEF SUMMARY OF THE INVENTION

An embodiment of the disclosure meets the needs presented above by generally comprising a first shield that is selectively worn on an upper set of teeth. The first shield is comprised of a fluid impermeable material to inhibit food and liquid from contacting the upper set of teeth. The first shield is partially comprised of a deformable material. A first adhesive is positioned on the first shield to adhere to the upper set of teeth. A second shield is selectively worn on a lower set of teeth. The second shield is comprised of a fluid impermeable material to inhibit food and liquid from contacting the lower set of teeth. The second shield is partially comprised of a deformable material. A second adhesive is positioned on the second shield to adhere to the lower set of teeth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dental protection assembly according to an embodiment of the disclosure.

FIG. 2 is a top view of an embodiment of the disclosure.

FIG. 3 is a front view a first shield of an embodiment of the disclosure.

FIG. 4 is a perspective in-use view of an embodiment of the disclosure.

### DETAILED DESCRIPTION OF THE INVENTION

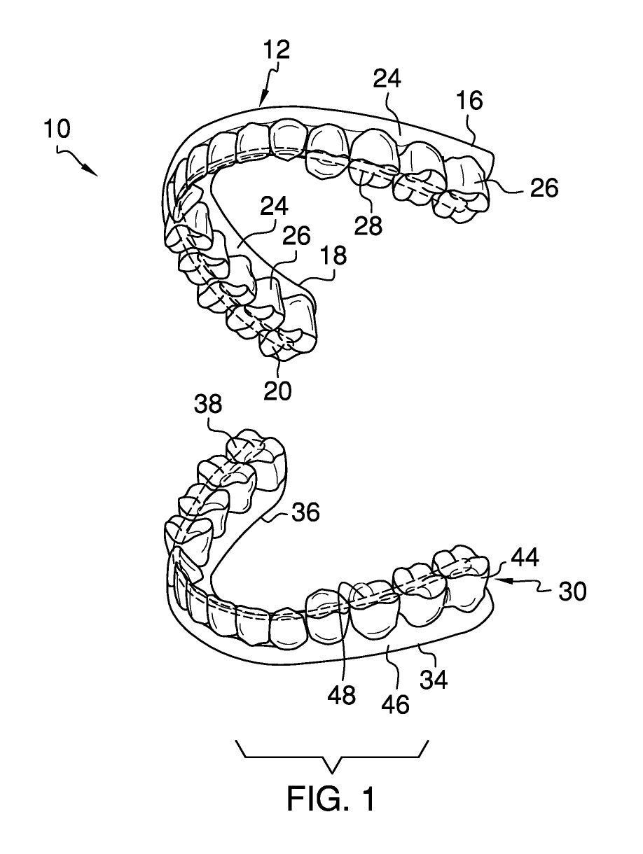

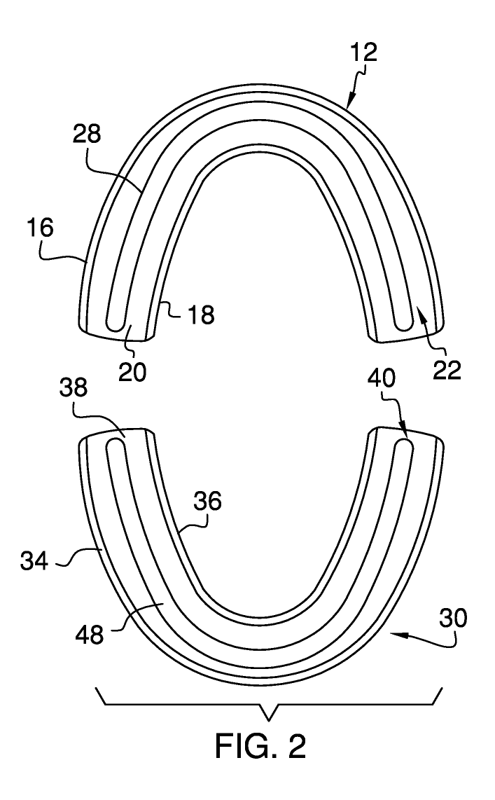

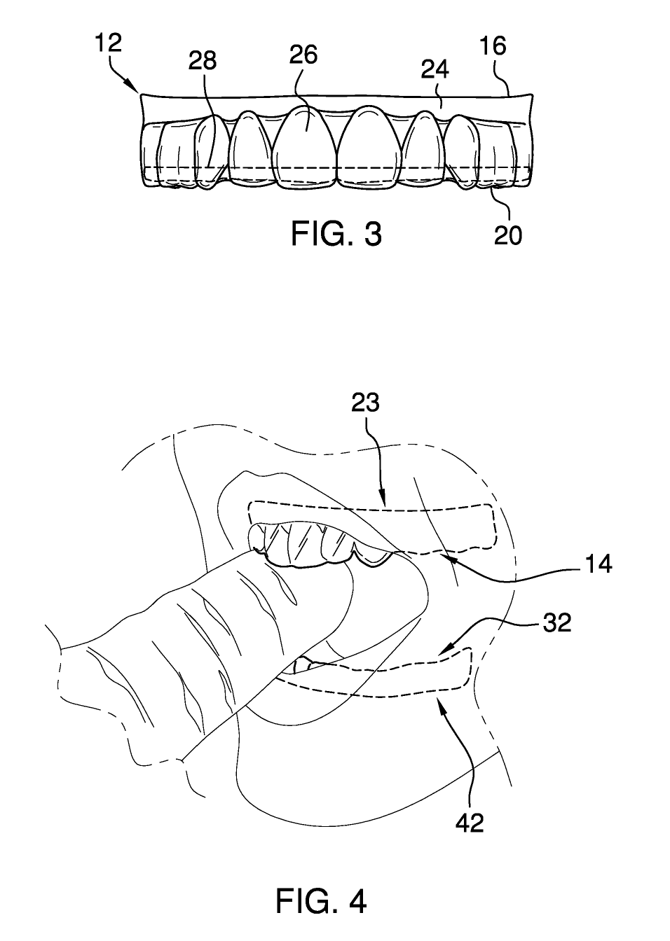

With reference now to the drawings, and in particular to FIGS. 1 through 4 thereof, a new dental device embodying the principles and concepts of an embodiment of the disclosure and generally designated by the reference numeral 10 will be described.

As best illustrated in FIGS. 1 through 4, the dental protection assembly 10 generally comprises a first shield 12 that is selectively worn on an upper set of teeth 14. The first shield 12 is comprised of a fluid impermeable material. In this way the first shield 12 inhibits food and liquid from contacting the upper set of teeth 14. Thus, the first shield 12 inhibits tooth decay resulting from eating and drinking.

The first shield 12 has a first wall 16, a second wall 18 and a basal wall 20 extending therebetween. Each of the first wall 16 and the second wall 18 extends upwardly from the basal wall 20. Moreover, the first wall 16 is spaced from the second wall 18 to define a first tooth space 22 in the first shield 12. The first tooth space 22 insertably receives the upper set of teeth 14 having the upper set of teeth 14 abutting the basal wall 20. Each of the first wall 16 and the second wall 18 is concavely arcuate such that the first shield 12 forms a U-shape. Additionally, each of the first 16 and second 18 walls extend up to an upper threshold of an upper set of gums 23 when the first shield 16 is worn.

Each of the first wall 16 and the second wall 18 has a lower half 24 and an upper half 26. The basal wall 20 and the lower half 24 corresponding to each of the first 16 and second 18 walls is comprised of a rigid material. Thus, the basal wall 20 and the lower half 24 facilitate chewing when the first shield 12 is worn. The rigid material may be a clear, medical grade polymer or the like. The upper half 26 corresponding to each of the first 16 and second 18 walls is comprised of a deformable material to enhance comfort on the upper set of gums 23 when the first shield 12 is worn. The deformable material may be a clear, tensile polymer or the like.

A first adhesive 28 is provided and the first adhesive 28 is positioned on in the first shield 12. The first adhesive 28 adheres to the upper set of teeth 14 thereby facilitating the first shield 12 to be removably retained on the upper set of teeth 14. The first adhesive 28 is infused with fluoride. Thus, the first adhesive 28 promotes dental health when the first shield 12 is worn. Additionally, the first adhesive 28 forms a fluid impermeable adhesion with the upper set of teeth 14. The first adhesive 28 may be a denture adhesive or the like that facilitates the first shield 12 to be selectively removed without damaging the upper set of teeth 14. The first adhesive 28 may be laid as a strip along the basal wall 20.

A second shield 30 is provided and the second shield 30 is selectively worn on a lower set of teeth 32. The second shield 30 is comprised of a fluid impermeable material. In this way the second shield 30 inhibits food and liquid from contacting the lower set of teeth 32. Thus, the second shield 30 inhibits tooth decay.

The second shield 30 has a primary wall 34, a secondary wall 36 and a top wall 38 extending therebetween. Each of the primary wall 34 and the secondary wall 36 extends downwardly from the top wall 38. Moreover, the primary wall 34 is spaced from the secondary wall 36 to define a second tooth space 40 in the second shield 30. The second tooth space 40 insertably receives the lower set of teeth 32 having the lower set of teeth 32 abutting the top wall 38. Each of the primary wall 34 and the secondary wall 36 is concavely arcuate such that the second shield 30 forms a U-shape. Each of the primary 34 and secondary 36 walls extend down to a lower threshold of a lower set of gums 42 when the second shield 30 is worn.

Each of the primary wall 34 and the secondary wall 36 has a top half 44 and a bottom half 46. The top wall 38 and the top half 44 corresponding to each of the primary 34 and secondary 36 walls are comprised of a rigid material. Thus, the top wall 38 and the bottom half 46 facilitate chewing. The rigid material may be a clear, medical grade polymer or the like. The bottom half 46 corresponding to each of the primary 34 and secondary 36 walls is comprised of a deformable material. In this way the bottom half 46 enhances comfort on a lower set of gums 42 when the second shield 30 is worn. The deformable material may be a clear, tensile polymer or the like.

A second adhesive 48 is provided and the second adhesive 48 is positioned in the second shield 30. The second adhesive 48 adheres to the lower set of teeth 32 thereby facilitating the second shield 30 to be removably retained on the lower set of teeth 32. The second adhesive 48 is infused with fluoride. Thus, the second adhesive 48 promotes dental health when the second shield 30 is worn. Additionally, the second adhesive 48 forms a fluid impermeable adhesion with the upper set of teeth 14. The second adhesive 48 may be a denture adhesive or the like that facilitates the second shield 30 to be selectively removed without damaging the upper set of teeth 14. The second adhesive 48 may be laid as a strip along the top wall 38.

In use, a dental impression of the upper set of teeth 14 and the lower set of teeth 32 is produced by a dentist. The dental impression is subsequently sent to a manufacturing facility to produce a mass quantity of the first shield 12 and the second shield 30. In this way each of the first 12 and second 30 shields conforms to a specific user's dentition. Each of the first shield 12 and the second shield 30 are worn prior to eating and drinking. Thus, each of the first shield 12 and the second shield 30 inhibits tooth decay resulting from food particles and beverages contacting the upper 14 and lower 32 sets of teeth. The first shield 12 and the second shield 30 are removed when eating and drinking are finished. Moreover, the first shield 12 and the second shield 30 are discarded when the first 12 and second 30 shields are removed. A new pair of first 12 and second 30 shields is taken from the mass quantity before eating and drinking. Thus, the first 12 and second 30 shields enhance dental health over an extended period of time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dental protection assembly being configured to be selectively worn while eating thereby inhibiting tooth decay, said assembly comprising:
a first shield being configured to be worn on an upper set of teeth, said first shield being comprised of a fluid impermeable material wherein said first shield is configured to inhibit food and liquid from contacting the upper set of teeth, said first shield being partially comprised of a deformable material;
a first adhesive being positioned on said first shield wherein said first adhesive is configured to adhere to the upper set of teeth thereby facilitating said first shield to be removably retained on the upper set of teeth;
a second shield being configured to be worn on a lower set of teeth, said second shield being comprised of a fluid impermeable material wherein said second shield is configured to inhibit food and liquid from contacting the lower set of teeth, said second shield being partially comprised of a deformable material; and
a second adhesive being positioned on said second shield wherein said second adhesive is configured to adhere to the lower set of teeth thereby facilitating said second shield to be removably retained on the lower set of teeth.

2. The assembly according to claim 1, wherein said first shield has a first wall, a second wall and a basal wall extending therebetween, each of said first wall and said second wall extending upwardly from said basal wall, said first wall being spaced from said second wall to define a first tooth space in said first shield wherein said first tooth space is configured to insertably receive the upper set of teeth having the upper set of teeth abutting said basal wall, each of said first wall and said second wall being concavely arcuate such that said first shield forms a U-shape.

3. The assembly according to claim 2, wherein each of said first wall and said second wall has a lower half and an upper half, said basal wall and said lower half corresponding to each of said first and second walls being comprised of a rigid material wherein said basal wall and said lower half is configured to facilitate chewing, said upper half corresponding to each of said first and second walls being comprised of the deformable material wherein said upper half is configured to enhance comfort on an upper set of gums when said first shield is worn.

4. The assembly according to claim 1, wherein said second shield has a primary wall, a secondary wall and a top wall extending therebetween, each of said primary wall and said secondary wall extending downwardly from said top wall, said primary wall being spaced from said secondary wall to define a second tooth space in said second shield wherein said second tooth space is configured to insertably receive the lower set of teeth having the lower set of teeth abutting said top wall, each of said primary wall and said secondary wall being concavely arcuate such that said second shield forms a U-shape.

5. The assembly according to claim 4, wherein each of said primary wall and said secondary wall has a top half and an bottom half, said top wall and said top half corresponding to each of said primary and secondary walls being comprised of a rigid material wherein said top wall and said bottom half is configured to facilitate chewing, said bottom half corresponding to each of said primary and secondary walls being comprised of the deformable material wherein said bottom half is configured to enhance comfort of an lower set of gums when said second shield is worn.

6. A dental protection assembly being configured to be selectively worn while eating thereby inhibiting tooth decay, said assembly comprising:
a first shield being configured to be worn on an upper set of teeth, said first shield being comprised of a fluid impermeable material wherein said first shield is configured to inhibit food and liquid from contacting the upper set of teeth, said first shield having a first wall, a second wall and a basal wall extending therebetween, each of said first wall and said second wall extending upwardly from said basal wall, said first wall being spaced from said second wall to define a first tooth space in said first shield wherein said first tooth space is configured to insertably receive the upper set of teeth having the upper set of teeth abutting said basal wall, each of said first wall and said second wall being concavely arcuate such that said first shield forms a U-shape, each of said first wall and said second wall having a lower half and an upper half, said basal wall and said lower half corresponding to each of said first and second walls being comprised of a rigid material wherein said basal wall and said lower half is configured to facilitate chewing, said upper half corresponding to each of said first and second walls being comprised of a deformable material wherein said upper half is configured to enhance comfort on an upper set of gums when said first shield is worn;
a first adhesive being positioned on said first shield wherein said first adhesive is configured to adhere to the upper set of teeth thereby facilitating said first shield to be removably retained on the upper set of teeth;
a second shield being configured to be worn on a lower set of teeth, said second shield being comprised of a fluid impermeable material wherein said second shield is configured to inhibit food and liquid from contacting the lower set of teeth, said second shield having a primary wall, a secondary wall and a top wall extending therebetween, each of said primary wall and said secondary wall extending downwardly from said top wall, said primary wall being spaced from said secondary wall to define a second tooth space in said second shield wherein said second tooth space is configured to insertably receive the lower set of teeth having the lower set of teeth abutting said top wall, each of said primary wall and said secondary wall being concavely arcuate such that said second shield forms a U-shape, each of said primary wall and said secondary wall having a top half and an bottom half, said top wall and said top half corresponding to each of said primary and secondary walls being comprised of a rigid material wherein said top wall and said top half is configured to facilitate chewing, said bottom half corresponding to each of said primary and secondary walls being comprised of a deformable material wherein said bottom half is configured to enhance comfort of an lower set of gums when said second shield is worn; and
a second adhesive being positioned on said second shield wherein said second adhesive is configured to adhere to the lower set of teeth thereby facilitating said second shield to be removably retained on the lower set of teeth.
